(19) United States
(12) Patent Application Publication
(10) Pub. No.: US 2024/0100612 A1
(43) Pub. Date: Mar. 28, 2024

(54) Method for Producing Tooth Flank Modifications on Tooth Flanks of a Workpiece Toothing of a Workpiece

(71) Applicant: Präwema Antriebstechnik GmbH, Eschwege/Werra (DE)

(72) Inventors: Jörg Schieke, Erfurt-Marbach (DE); Walter Holderbein, Eschwege (DE); Jörg Reinhardt, Berka v.d.H. (DE)

(21) Appl. No.: 18/373,535

(22) Filed: Sep. 27, 2023

(30) Foreign Application Priority Data
Sep. 28, 2022 (DE) 10 2022 124 966.2

(51) Int. Cl. B23F 1/06

(52) U.S. Cl. CPC B23F 1/06

(57) ABSTRACT

Described and shown is a method for producing tooth flank modifications, in particular twists, on tooth flanks of at least one workpiece toothing of at least one workpiece, in particular gear wheel. In order that the production of tooth flank modifications on workpiece toothings of workpieces can be carried out more economically, it is provided that the production of the tooth flank modifications is carried out by skiving by means of a skiving tool, that the workpiece is driven in a rotating manner about a workpiece rotation axis and the skiving tool is driven in a rotating manner about a tool rotation axis arranged at an axis cross angle obliquely, in particular skew, to the workpiece rotation axis, in that the skiving tool, in particular rotating about the tool rotation axis , is brought into chipping engagement with the workpiece, in particular rotating about the workpiece rotation axis, in that the skiving tool being in chipping engagement with the workpiece and rotating about the tool rotation axis is moved relative to the workpiece rotating about the workpiece rotation axis along a longitudinal axis at least substantially parallel to the workpiece rotation axis or the tool rotation axis, and in that, in order to produce the tooth flank modifications, the skiving tool moving along the longitudinal axis is moved relative to the workpiece along at least one transverse axis at least substantially perpendicular to the longitudinal axis.

### CROSS-REFERENCE TO RELATED APPLICATION

This application claims priority to German Patent Application No. 10 2022 124 966.2 filed Sep. 28, 2022, the disclosure of which is hereby incorporated by reference in its entirety.

### BACKGROUND OF THE INVENTION

### Field of the Invention

The invention relates to a method for producing tooth flank modifications, in particular twists, on tooth flanks of at least one workpiece toothing of at least one workpiece, in particular gear wheel, by skiving by means of a skiving tool.

### Description of Related Art

Skiving is a chipping machining method with geometrically defined cutting edge which is usually used to produce workpiece toothings on workpieces such as gear wheels for example for gearboxes. In skiving, the workpiece and a skiving tool with which the workpiece is chipping machined are driven in a rotating manner. It is characteristic of skiving that the workpiece rotation axis, about which the workpiece rotates, and the tool rotation axis, about which the skiving tool rotates, are arranged at an axis cross angle obliquely to each other. For the machining of the workpiece, the skiving tool is brought into chipping engagement with the workpiece. Then, the skiving tool being in chipping engagement with the workpiece and rotating about the tool rotation axis is moved relative to the workpiece rotating about the workpiece rotation axis along a longitudinal axis which is arranged at least substantially parallel to the workpiece rotation axis or tool rotation axis. During the movement along the longitudinal axis, the skiving tool typically produces the tooth gaps between the workpiece teeth of the workpiece toothing.

It is known that the operating behavior of toothings, for example of gear wheels, can be influenced not only by the macro geometry of the toothing, such as for example the tooth width of the teeth of the toothing, the number of the teeth and the module, but also by the micro geometry of the tooth flanks of the teeth. Thus, a targeted production of so-called tooth flank modifications on the tooth flanks can prevent that during use, an uneven loading of the tooth flanks and/or deformations of the teeth occur due to the forces acting on the teeth. In this way, in particular, tooth meshing impacts can be avoided and the contact pattern of the toothing can be improved, which finally enables greater load-carrying capacity, longer service life, more uniform power transmission and better noise behavior.

Tooth flank modifications on workpiece toothings of workpieces are usually produced in that the workpiece toothing produced, for example, during chipping rough machining for example by skiving is fine machined by means of a typically resin- or ceramic-bonded tool with geometrically undefined cutting edge. This fine machining is usually performed by generating grinding by means of a grinding tool or by gear honing by means of a honing tool. To reduce the machining time, the fine machining tools often have a geometry which corresponds to the desired geometry of the workpiece toothing and which is transferred to the workpiece toothing during the fine machining. Before initial use and after a certain period of use and the accompanying wear, respective tools are typically dressed with a dressing tool to (re-)produce the desired tool geometry.

With the known methods, tooth flank modifications cannot yet be produced on workpieces with the desired economic efficiency.

### SUMMARY OF THE INVENTION

Therefore, the present invention is based on the task of designing and further developing the method of the type mentioned at the beginning and described in more detail above in such a way that the production of tooth flank modifications on workpiece toothings of workpieces can be carried out more economically.

This task is solved as described herein by a method for producing tooth flank modifications, in particular twists, on tooth flanks of at least one workpiece toothing of at least one workpiece, in particular gear wheel, by skiving by means of a skiving tool,
in which the workpiece is driven in a rotating manner about a workpiece rotation axis and the skiving tool is driven in a rotating manner about a tool rotation axis arranged at an axis cross angle obliquely, in particular skew, to the workpiece rotation axis,
in which the skiving tool, in particular rotating about the tool rotation axis, is brought into chipping engagement with the workpiece, in particular rotating about the workpiece rotation axis,
in which the skiving tool being in chipping engagement with the workpiece and rotating about the tool rotation axis is moved relative to the workpiece rotating about the workpiece rotation axis along a longitudinal axis at least substantially parallel to the workpiece rotation axis or the tool rotation axis, and
in which, in order to produce the tooth flank modifications, the skiving tool moving along the longitudinal axis is moved relative to the workpiece along at least one transverse axis at least substantially perpendicular to the longitudinal axis.

The invention has recognized that by skiving, tooth flank modifications can be produced in a particularly economical manner on tooth flanks of a workpiece toothing of a workpiece. For this purpose, the skiving tool, while it is moved relative to the workpiece, in particular continuously and/or translationally, along the longitudinal axis, is additionally moved relative to the workpiece, in particular continuously and/or translationally, along a transverse axis which is arranged at least substantially perpendicular to the longitudinal axis. Thus, the movement of the skiving tool along the transverse axis in particular contributes to the production of the tooth flank modifications. In this way, for example, the workpiece can be brought closer to the desired final geometry prior to fine machining, thus reducing not only the time required for the subsequent fine machining but also the overall machining time. The production of the tooth flank modifications can, for example, compensate for distortions due to hardening that can occur on the workpiece during heat treatment which, if required, takes place between the skiving machining and the fine machining.

Although it should not be ruled out in principle, the shape of the tooth flank modification to be produced with the skiving tool does not have to be incorporated into the skiving tool, at least not exactly. Rather, the production of the tooth flank modifications can preferably take place at least substantially exclusively by movements of the skiving tool relative to the workpiece. This enables the production of differently designed tooth flank modifications with the same skiving tool. Irrespective of this, it is conceivable in principle that, in order to produce the tooth flank modifications, the skiving tool is moved relative to the workpiece along two transverse axes at least substantially perpendicular to each other and to the longitudinal axis. However, with regard to a low machine and control effort, it is preferred if the skiving tool and the workpiece are moved relative to each other only along one transverse axis perpendicular to the longitudinal axis.

A tooth flank modification is preferably understood to mean an, in particular continuous, change in the cross section of a workpiece tooth, in particular of a tooth flank of a workpiece tooth, of the workpiece toothing over the tooth width of the workpiece tooth. Irrespective of this, it can have a positive effect on the operating behavior of the workpiece if the tooth flank modifications extend in each case over at least 20%, preferably at least 50%, in particular at least 80%, of the tooth width of the associated workpiece tooth of the workpiece toothing. The tooth width of a workpiece tooth in principle means, for example, its extension along the workpiece rotation axis.

The tooth flank modifications can in particular be so-called twists. The production of twists is typically particularly laborious, so that the advantages of the invention are particularly effective. A twist of a tooth flank preferably means a twisting of the tooth flank, in particular about the flank line of the tooth flank.

The workpiece is preferably not a tool that in turn is itself intended for, in particular chipping, machining workpieces. Rather, the workpiece can be intended for power transmission, for example in a gearbox. Accordingly, the skiving tool is preferably also not a dressing tool, which is intended in particular for dressing other tools.

The workpiece can preferably be a, for example internally toothed and/or externally toothed, gear wheel, for example for a gearbox. In practice, gear wheels are particularly frequently to be provided with tooth flank modifications, so that the advantages of the invention are particularly effective. Regardless of the design of the workpiece, the skiving tool can expediently have a plurality of cutting edges which come into chipping engagement with the workpiece during the production of the tooth flank modifications.

The tool rotation axis and the workpiece rotation axis can preferably be arranged skew to each other. Then, in particular, the rotation axes do not intersect. Irrespective of this, the axis cross angle between the tool rotation axis and the workpiece rotation axis during the chipping machining of the workpiece can be, for example, at least 5° and/or at most 40°. An axis cross angle of at least 10°, if required at least 15°, and/or at most 35°, if required at most 30°, can be particularly preferred with regard to efficient machining.

The skiving tool can conveniently rotate about the tool rotation axis when the skiving tool is brought into chipping engagement with the workpiece. Alternatively or additionally, for the same reason, the workpiece can also rotate about the workpiece rotation axis when the skiving tool is brought into chipping engagement with the workpiece.

The movement of the skiving tool relative to the workpiece along the longitudinal axis serves in particular to move the skiving tool along the workpiece teeth of the workpiece toothing. It can therefore be expedient if the distance that the skiving tool being in chipping engagement with the workpiece is moved along the longitudinal axis is at least 50%, preferably at least 75%, in particular at least 90%, of the tooth width of the workpiece teeth of the workpiece toothing. In this context, it can be particularly preferred if the respective distance is at least as long as the tooth width of the workpiece teeth.

The workpiece can simply and conveniently be driven in a rotating manner about the workpiece rotation axis by a workpiece rotation drive. Alternatively or additionally, for the same reason, the skiving tool can be driven in a rotating manner about the tool rotation axis by a tool rotation drive. Irrespective of this, the skiving tool can be moved relative to the workpiece along the longitudinal axis and/or the transverse axis by at least one actuating drive, for example linear drive. Preferably, at least two actuating drives are provided, wherein one can be provided for the movement along the longitudinal axis and the other for the movement along the transverse axis. The at least one drive can, for example, be part of a machine tool.

In a first particularly preferred embodiment of the method, the axis cross angle between the tool rotation axis and the workpiece rotation axis is maintained unchanged while the tooth flank modifications are produced. Then, the axis cross angle can thus remain unchanged as long as the skiving tool is in chipping engagement with the workpiece. In this way, the machine and control effort can be reduced. This is because then a device that continuously adjusts the axis cross angle and corresponding control mechanisms can be dispensed with. Rather, the axis cross angle can be set in a simple manner, for example by means of a simple setting device, before the skiving tool is brought into chipping engagement with the workpiece. During the subsequent chipping machining of the workpiece, the axis cross angle can then remain at least substantially constant.

A particularly low machine and control effort is made possible if the tooth flank modifications are produced at least substantially exclusively by the movement of the skiving tool relative to the workpiece along the longitudinal axis and the transverse axis. Then, the shape of the tooth flank modifications can thus be influenced at least substantially exclusively by the movements of the skiving tool relative to the workpiece along the longitudinal axis and the transverse axis. A shape of the skiving tool adapted to the tooth flank modifications to be produced can then be dispensable. Irrespective of this, for the sake of simplicity, it can also be provided that the skiving tool being in chipping engagement with the workpiece is moved exclusively along the longitudinal axis and the transverse axis relative to the workpiece when producing the tooth flank modifications.

With regard to kinematically simple production even of complex tooth flank modifications, it can be useful if the transverse axis is arranged at least substantially parallel to a straight line that runs tangentially to the workpiece rotation axis or tool rotation axis through a point of contact between the skiving tool and the workpiece. The respective straight line thus runs in particular tangentially to the workpiece rotation axis or the tool rotation axis and, in addition, through a point in which the skiving tool and the workpiece are in contact.

The skiving tool can expediently have tool teeth that come into chipping engagement with the workpiece during the production of the tooth flank modifications. Then, the tool teeth can provide the cutting edges of the skiving tool. Irrespective of this, in terms of simple and cost-effective manufacture of the skiving tool, it can be useful if the tool teeth are each designed as one piece. Alternatively or additionally, the tool teeth can simply and expediently be provided on a circumference, for example an outer circumference or inner circumference, of the skiving tool. Then, preferably, the tooth tips of the tool teeth can point outward or inward in the radial direction with respect to the tool rotation axis.

Irrespective of the design and arrangement of the tool teeth, it can be useful for the sake of simplicity if the skiving tool has at least one tool toothing that comprises the tool teeth. The tool toothing can expediently be designed circumferentially around the tool rotation axis. Irrespective of this, the tool toothing can be designed, for example, as external toothing. This allows flexible use of the skiving tool. This is because an externally toothed skiving tool enables the production of tooth flank modifications on both external toothings and internal toothings. If the tool toothing is designed as external toothing, the workpiece toothing can thus in principle be an internal toothing or an external toothing. However, due to the short machining time, an externally toothed skiving tool offers particular advantages when producing tooth flank modifications on internal toothings. Alternatively to an external toothing, the tool toothing can be an internal toothing. A tool toothing in the form of an internal toothing is particularly suitable for producing tooth flank modifications on external toothings. If the tool toothing is designed as internal toothing, the workpiece toothing can thus in particular be an external toothing. Irrespective of a design of the tool toothing as external or internal toothing, it can also be useful in terms of a versatile use of the skiving tool if the skiving tool has at least two tool toothings. Then, for example, one of the tool toothings can be an external toothing and the other tool toothing can be an internal toothing.

In order to be able to move the skiving tool particularly freely during the chipping machining of the workpiece without the tool teeth coming into contact with the workpiece in an undesirable manner, it can be useful if the tooth width of the tool teeth is at most 30 mm. This enables simple production, from a kinematic point of view, even of complex tooth flank modifications, such as twists, and in particular without the shape of the skiving tool, especially of the cutting edges, being adapted to the geometry of the tooth flank modification to be produced. Against this background, a tooth width of the tool teeth of at most 20 mm, preferably at most 15 mm, can be even more useful. In this context, a tooth width of the tool teeth of at most 10 mm is particularly preferred. Alternatively or additionally to a respective upper limit, it can be provided that the tooth width of the tool teeth is at least 3 mm. This can be advantageous with regard to a high stability and service life of the tool teeth. For the same reason, a tooth width of the tool teeth of at least 5 mm, preferably at least 6 mm, can be particularly useful. With regard to a simple and cost-effective design of the skiving tool, it can be particularly useful if not only the tool teeth have a respective maximum and/or minimum width, but the skiving tool as a whole.

Alternatively or additionally, with regard to a kinematically simple production in particular of complex tooth flank modifications and thus a versatile use of the skiving tool, it can also be useful if the tooth width of the tool teeth is at most 1.5 times the tooth width of the workpiece teeth of the workpiece toothing. For the same reason, it can be even more useful if the tooth width of the tool teeth is less than or equal to the tooth width of the workpiece teeth. In this context, it is particularly preferred if the tooth width of the tool teeth is at most 0.5 times, in particular at most 0.1 times, the tooth width of the workpiece teeth.

In principle, the tooth width of the tool teeth preferably means the extension of the tool teeth along the tool rotation axis. Irrespective of this, the tooth width of the workpiece teeth preferably means the extension of the workpiece teeth along the workpiece rotation axis.

A structurally simple and at the same time particularly expedient design of the skiving tool is made possible if the skiving tool has at least substantially the shape of a disk. Then, for example, the extension of the skiving tool perpendicular to the tool rotation axis can be greater, in particular by a multiple, than the extension of the skiving tool along the tool rotation axis. Alternatively or additionally to a disk-shaped design, the skiving tool can have at least substantially the shape of a ring. An annular design can be useful with regard to simple mounting of the skiving tool, for example on a tool spindle, and/or when the workpiece toothing is designed as internal toothing.

The workpiece can be formed at least substantially from a metallic material. In practice, metallic workpieces are particularly frequently to be provided with tooth flank modifications, so that the advantages of the invention are particularly effective. This applies all the more to workpieces which are at least substantially formed from a steel material. A case-hardening steel, for example 20MnCr5, is particularly suitable as a steel material.

Regardless of the material of the workpiece, the skiving tool can be formed at least substantially from a high-speed steel, which in practice is often also referred to as “HSS”, and/or a hard metal material. This allows good tool properties at moderate costs. To increase the tool service life, the high-speed steel and/or the hard metal material can be coated.

In principle, it is conceivable that the workpiece toothing is produced on the workpiece with a tool other than the skiving tool and/or with a machining method other than skiving, and subsequently the tooth flank modifications are introduced into the workpiece toothing produced in this way with the skiving tool. With regard to short cycle times, however, it is particularly useful if not only the tooth flank modifications are produced with the skiving tool, but also the workpiece toothing is produced on the workpiece by skiving with the skiving tool. In this context, the production of the workpiece toothing is preferably understood to mean the introduction of the tooth gaps between the workpiece teeth of the workpiece toothing into an untoothed or only roughly pre-toothed section of the workpiece, wherein the introduction into an untoothed section can be particularly preferred with regard to short manufacturing times. Thus, during the production of the workpiece toothing, the desired macro geometry of the workpiece can in particular be manufactured. Irrespective of this, the production of the workpiece toothing can, if required, be carried out in two or more passes, wherein after each pass the depth of engagement of the skiving tool into the workpiece in relation to the tip diameter of the workpiece toothing can expediently be increased.

If the production of the workpiece toothing is carried out with the skiving tool, for example, first the workpiece toothing without the tooth flank modifications can be produced with the skiving tool. Following this, the tooth flank modifications can then be produced on the produced workpiece toothing, wherein only a few micrometers of the workpiece material can be removed. Then, if required, the skiving tool is thus moved along the longitudinal axis during the production of the workpiece toothing, without being additionally moved perpendicular to the longitudinal axis. With regard to short machining times, however, it can be particularly preferred if the production of the tooth flank modifications takes place at least partially during the production of the workpiece toothing. Then, the tooth flank modifications are preferably produced at least partially together with the introduction of the tooth gaps of the workpiece toothing into the workpiece. Irrespective of this, particularly short machining times can be achieved if the production of the tooth flank modifications takes place not only partially, but at least substantially during the production of the workpiece toothing.

In practice, it is often not just one workpiece that has to be provided with tooth flank modifications, but several workpieces. It can therefore be useful if tooth flank modifications are produced successively on at least two workpieces with the skiving tool. It can be simple and expedient if the skiving tool is arranged on a tool spindle, for example of a machine tool, prior to the machining of the at least two workpieces and remains arranged on the tool spindle until after the machining of the at least two workpieces.

### BRIEF DESCRIPTION OF THE INVENTION

The invention is explained in more detail below by means of a drawing showing only one exemplary embodiment. In the drawing,

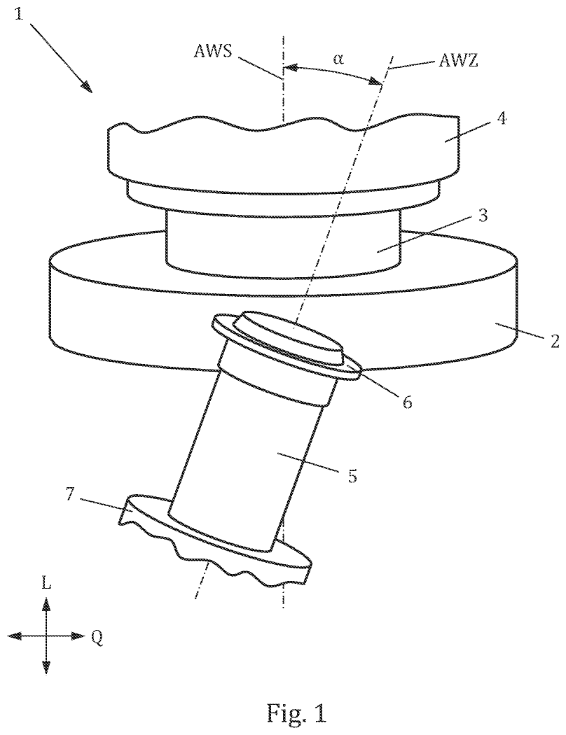

FIG. 1 schematically shows a section of a machine tool for carrying out the method according to the invention in a perspective view,

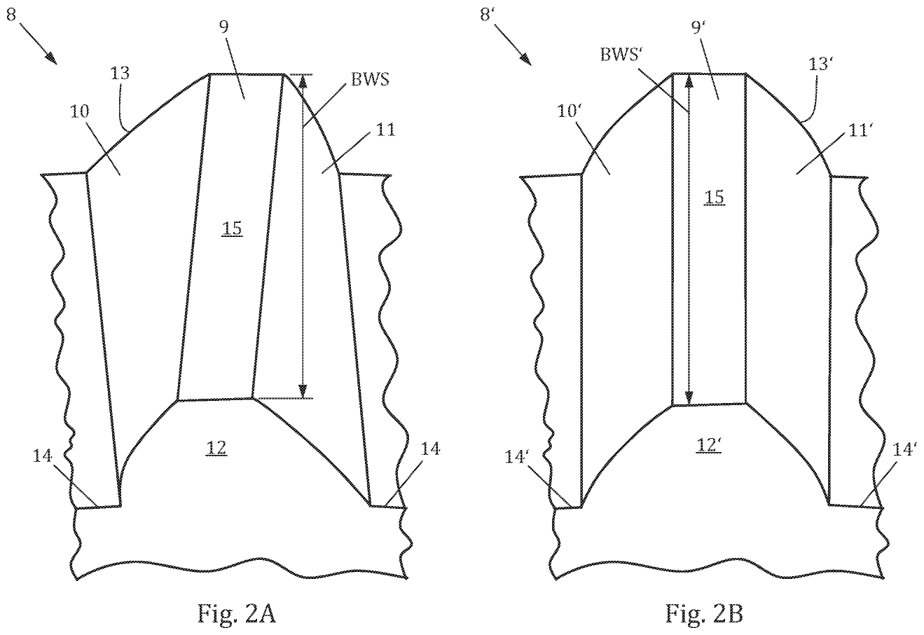

FIGS. 2A-B schematically show a section of a workpiece toothing with and without tooth flank modifications in each case in a perspective view,

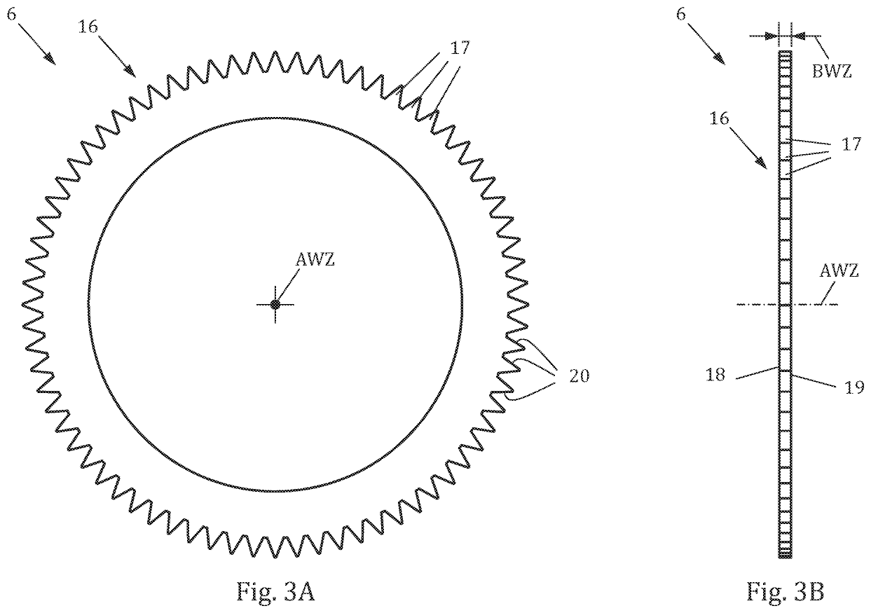

FIGS. 3A-B schematically show a skiving tool of the machine tool from FIG. 1 in a top view and a side view,

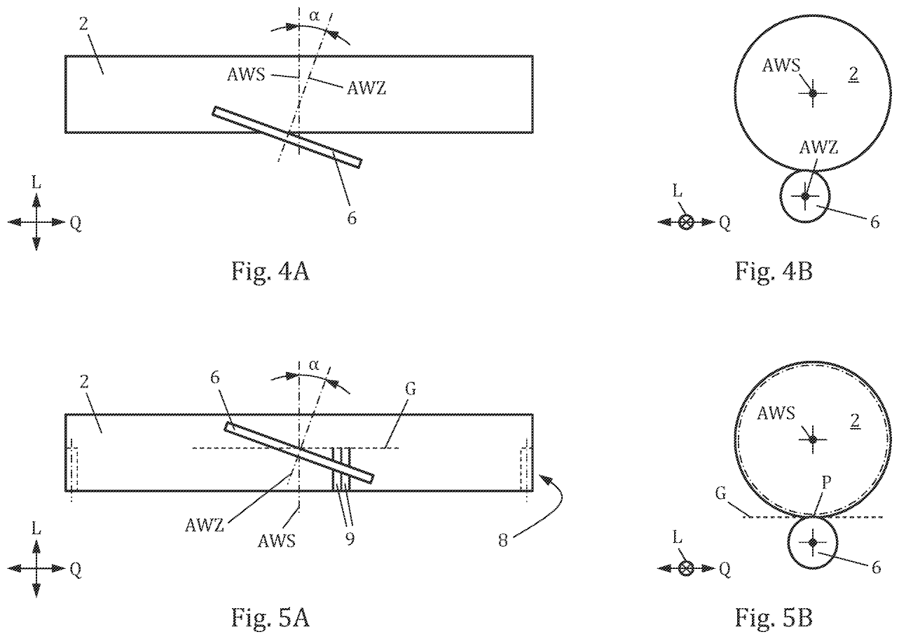

FIGS. 4A-6B schematically show the skiving tool and the workpiece from FIG. 1 in different positions relative to each other in each case in a side view and a top view.

### DESCRIPTION OF THE INVENTION

In FIG. 1, a section of a machine tool 1 and a workpiece 2 is shown in a perspective view. The machine tool 1 comprises a workpiece spindle 3 which carries the workpiece 2. The workpiece spindle 3 is coupled to a workpiece rotation drive 4, by means of which the workpiece spindle 3 and, via it, the workpiece 2 carried by the workpiece spindle 3 can be driven in a rotating manner about a workpiece rotation axis AWS.

The machine tool 1 further comprises a tool spindle 5. The tool spindle 5 carries a disk-shaped skiving tool 6, which is clamped on the tool spindle 5. The tool spindle 5 is coupled to a tool rotation drive 7, by means of which the tool spindle 5 and the skiving tool 6 carried by the tool spindle 5 can be driven in a rotating manner about a tool rotation axis AWZ. In the present case, the tool rotation axis AWZ is arranged at an axis cross angle a of approx. 20° obliquely and skew to the workpiece rotation axis AWS.

The machine tool 1 further has two actuating drives, not shown, for example designed as linear drives, in order to be able to move the tool spindle 5 together with the skiving tool 6 relative to the workpiece spindle 3 and the workpiece 2. One of the actuating drives is provided to move the tool spindle 5 translationally along a longitudinal axis L, which in the present case is arranged at least substantially parallel to the workpiece rotation axis AWS, relative to the workpiece spindle 3. The other actuating drive is provided to move the tool spindle 5 translationally along a transverse axis Q which is at least substantially perpendicular to the longitudinal axis L, relative to the workpiece spindle 3. In addition, the machine tool 1 has a setting device, also not shown, with which the axis cross angle a can be set and fixed.

In FIGS. 2A-B, a section of a workpiece toothing 8 to be produced on the workpiece 2 with tooth flank modifications and a section of a workpiece toothing 8′ without tooth flank modifications are each shown in the region of a workpiece tooth 9,9′ of the workpiece toothing 8,8′ in a perspective view. The workpiece teeth 9,9′ each have two opposing tooth flanks 10,10′,11,11′, which each extend from one front side 12,12′ of the workpiece tooth 9,9′ to the opposite front side 13,13′ of the workpiece tooth 9,9′ and from the root circle 14,14′ of the workpiece toothing 8,8′ to the tip surface 15,15′ of the workpiece tooth 9,9′.

The workpiece tooth 9 shown in FIG. 2A has a tooth flank modification on both tooth flanks 10, 11 in the form of a twist. In the present case, the cross sections of the tooth flanks 10, 11 each change continuously over the entire tooth width BWS of the workpiece tooth 9. The tooth flank modifications of the tooth flanks 10, 11 thus extend over the entire tooth width BWS of the workpiece tooth 9 in the shown and insofar preferred exemplary embodiment.

In contrast, the workpiece tooth 9′ shown in FIG. 2B has no tooth flank modification. Instead, the workpiece tooth 9′ has at least substantially the same cross section over the entire tooth width BWS′.

In FIGS. 3A-B, the skiving tool 6 is shown in a top view and a side view. The skiving tool 6, which is designed disk-shaped and ring-shaped in the present case, has on its outer circumference a tool toothing 16 being circumferential around the tool rotation axis AWZ, which tool toothing 16 comprises a plurality of tool teeth 17. The tool teeth 17 each have cutting edges 20 on their opposite front sides 18,19, which cutting edges 20 can extend, for example, over the complete profile of the respective tool tooth 17.

In the shown and insofar preferred exemplary embodiment, the tool teeth 17 extend over the entire width of the skiving tool 6. Thus, the tooth width BWZ of the tool teeth 17 corresponds in the present case to the width of the skiving tool 6. This can be preferred, but is not absolutely necessary. The tooth width BWZ of the tool teeth 17 is approx. 8 mm in the present case.

In FIGS. 4A-6B, the workpiece 2 and the skiving tool 6 are shown in different positions relative to each other in each case in a side view and a top view. In FIGS. 4A-B, the still untoothed workpiece 2 and the skiving tool 6 are disengaged. In order to produce the workpiece toothing 8 with the tooth flank modifications on the workpiece 2, the skiving tool 6 driven in a rotating manner about the tool rotation axis AWZ is brought into chipping engagement with the workpiece 2 driven in a rotating manner about the workpiece rotation axis AWS. For this purpose, the skiving tool 6 is moved in the present case translationally toward the workpiece 2 along a longitudinal axis L at least substantially parallel to the workpiece rotation axis AWS.

In order to introduce the tooth gaps between the workpiece teeth 9 of the workpiece toothing 8, the skiving tool 6 being in chipping engagement with the workpiece 2 is then further moved relative to the workpiece 2 along the longitudinal axis L. Meanwhile, the skiving tool 6 is additionally moved translationally relative to the workpiece 2 along a transverse axis Q at least substantially perpendicular to the longitudinal axis L in order to produce the tooth flank modifications on the workpiece teeth 9 together with the introduction of the workpiece toothing 8. In the course of this, the axis cross angle a between the tool rotation axis AWZ and the workpiece rotation axis AWS is kept at least substantially constant at a value of approx. 20°.

In FIGS. 5A-B, the skiving tool 6 rotating about the tool rotation axis AWZ is in chipping engagement with the workpiece 2 rotating about the workpiece rotation axis AWS. The workpiece toothing 8 of the workpiece 2 designed as external toothing 8 in the present case is partially produced, wherein only individual workpiece teeth 9 of the workpiece toothing 8 are shown for the sake of clarity.

The skiving tool 6 is further moved relative to the workpiece 2 along the longitudinal axis L and the transverse axis Q in order to produce the workpiece toothing 8 with the tooth flank modifications over the entire width of the workpiece 2 in the present case. In the course of this, the transverse axis Q is arranged at least substantially parallel to a straight line G, which runs tangentially to the workpiece rotation axis AWS and through a point of contact P, in which the skiving tool 6 and the workpiece 2 touch each other.

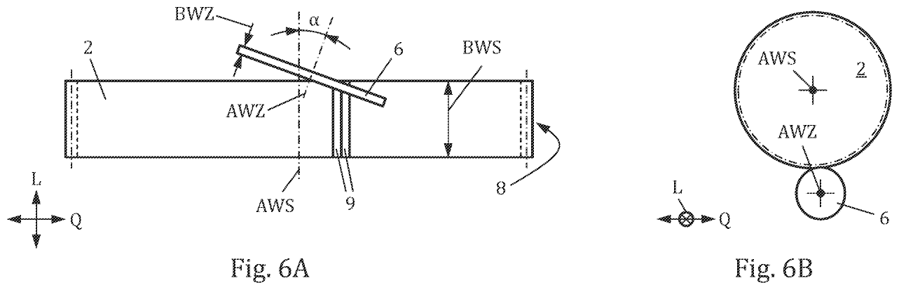

In FIGS. 6A-B, the skiving tool 6 and the workpiece 2 are again disengaged. The workpiece toothing 8 is produced over the entire width of the workpiece 2 at least partially. The tooth width BWS of the workpiece teeth 9 is in the present case approx. 80 mm. The ratio of the tooth width BWZ of the tool teeth 17, which in the present case is approx. 8 mm, to the tooth width BWS of the workpiece teeth 9 is thus approx. 0.1 in the shown and insofar preferred exemplary embodiment.

From the position shown in FIGS. 6A-B, the skiving tool 6 can be moved back again to the position shown in FIGS. 4A-B if required, for example in order to complete the workpiece toothing 8 in at least one further pass. Between the at least two passes, the center distance between the workpiece rotation axis AWS and the tool rotation axis AWZ can then expediently be reduced in order to increase the depth of engagement of the skiving tool 6 into the workpiece 2.

If the production of the workpiece toothing 8 is carried out in more than one pass, it is not absolutely necessary that the skiving tool 6 is moved along the transverse axis Q in addition to the movement along the longitudinal axis L in each of the passes in order to produce the tooth flank modifications, although this is not excluded. If multiple passes are provided, the skiving tool 6 can, for example, be moved in at least one pass only along the longitudinal axis L and, for producing the tooth flank modifications, in at least one subsequent pass along the transverse axis Q in addition to the movement along the longitudinal axis L.

### LIST OF REFERENCE SIGNS

1 machine tool
2 workpiece
3 workpiece spindle
4 workpiece rotation drive
5 tool spindle
6 skiving tool
7 tool rotation drive
8,8′ workpiece toothing
9,9′ workpiece tooth
10,10′,11,11′ tooth flank of a workpiece tooth
12,12′,13,13′ front side of a workpiece tooth
14,14′ root circle
15,15′ tip surface
16 tool toothing
17 tool tooth
18,19 front side of a tool tooth
20 cutting edge
AWS workpiece rotation axis
AWZ tool rotation axis
BWS,BWS′ tooth width of a workpiece tooth
BWZ tooth width of a tool tooth
G straight line
L longitudinal axis
P point of contact
Q transverse axis
α axis cross angle

1. A method for producing tooth flank modifications, in particular twists, on tooth flanks of at least one workpiece toothing of at least one workpiece, in particular gear wheel, by skiving by means of a skiving tool,
in which the workpiece is driven in a rotating manner about a workpiece rotation axis and the skiving tool is driven in a rotating manner about a tool rotation axis arranged at an axis cross angle obliquely, in particular skew, to the workpiece rotation axis,
in which the skiving tool, in particular rotating about the tool rotation axis, is brought into chipping engagement with the workpiece , in particular rotating about the workpiece rotation axis,
in which the skiving tool being in chipping engagement with the workpiece and rotating about the tool rotation axis is moved relative to the workpiece rotating about the workpiece rotation axis along a longitudinal axis at least substantially parallel to the workpiece rotation axis or the tool rotation axis, and
in which, in order to produce the tooth flank modifications, the skiving tool moving along the longitudinal axis is moved relative to the workpiece along at least one transverse axis at least substantially perpendicular to the longitudinal axis.

2) The method according to claim 1,
in which the axis cross angle is maintained at least substantially unchanged during the production of the tooth flank modifications, and
in which, preferably, the tooth flank modifications are produced at least substantially exclusively by the movement of the skiving tool relative to the workpiece along the longitudinal axis and the transverse axis.

3. The method according to claim 1,
in which the transverse axis is arranged at least substantially parallel to a straight line running tangentially to the workpiece rotation axis or tool rotation axis through a point of contact between the skiving tool and the workpiece.

4. The method according to claim 1,
in which the skiving tool has tool teeth coming into chipping engagement with the workpiece,
in which, preferably, the skiving tool has at least one tool toothing comprising the tool teeth, in particular being circumferential around the tool rotation axis and/or designed as external toothing or internal toothing.

5. The method according to claim 4,
in which the tooth width of the tool teeth is at most 30 mm, preferably at most 20 mm, in particular at most 15 mm, particularly preferably at most 10 mm, and/or at least 3 mm, preferably at least 5 mm, in particular at least 6 mm.

6. The method according to claim 4,
in which the ratio of the tooth width of the tool teeth to the tooth width of the workpiece teeth of the workpiece toothing is at most 1.5, preferably at most 1, in particular at most 0.5, particularly preferably at most 0.1.

7. The method according to claim 1,
in which the skiving tool is designed at least substantially disk-shaped and/or annular.

8. The method according to claim 1,
in which the workpiece is formed at least substantially from a metallic material, preferably steel material, in particular case-hardening steel, for example 20MnCr5, and/or
in which the skiving tool is formed at least substantially from a high-speed steel and/or hard metal material.

9. The method according to claim 1,
in which the workpiece toothing is produced on the workpiece by skiving by means of the skiving tool, and
in which the production of the tooth flank modifications takes place at least partially, in particular at least substantially, during the production of the workpiece toothing.

10. The method according to claim 1,
in which tooth flank modifications are produced successively on at least two workpieces with the skiving tool.
